(19) United States
(12) Patent Application Publication
(10) Pub. No.: US 2002/0054763 A1
(43) Pub. Date: May 9, 2002

(54) Telephone equipment, telecommunication system and caller identification method

(76) Inventor: Frederic Danis, Le Mans (FR)

Correspondence Address: Philips Electronics North America Corporation, 580 White Plains Road, Tarrytown, NY, 10591, US

(21) Appl. No.: 09/966,439

(22) Filed: Sep. 28, 2001

(30) Foreign Application Priority Data
Sep. 29, 2000 (FR) 0012460

(51) Int. Cl. G03B 17/48

(52) U.S. Cl. 396/429

(57) ABSTRACT

The invention relates to a method of refreshing the display screen at a variable rate, allowing a significant reduction of the power consumption of the display screen. It has particular applications in satellite-controlled equipment such as mobile telephones for selectively refreshing zones of the screen as a function of the position of the video objects which move from image to image, and of the motion vector characterizing their displacement and computed in accordance with a recommendation of the MPEG2 or 4 type.

The invention relates to the reception of video images with a view to their visualization on a display screen. The invention particularly relates to a method of refreshing the screen.

The invention has numerous applications, notably in the video transmission systems in conformity with a standard of the MPEG2 or 4 type (Motion Picture Experts Group).

European patent application EP 0 811 866 A1 discloses a method of refreshing a display screen for selectively refreshing a fixed image displayed on the screen as a function of the presence of active/inactive parts of the fixed image.

It is an object of the invention to provide a refreshing method allowing a significant reduction of the power consumption of display screens, particularly in satellite-controlled equipment such as mobile telephones.

The cited document relates to the display of fixed images in which active and inactive zones are defined. The cited document thus does not provide for the selective refreshing of zones of the screen as a function of motion information representing variations between two successive images, as is the case in the invention, which relates to the reception of video images comprising moving objects.

According to the invention, a receiver having a video display screen is provided for receiving successive encoded video images, the receiver comprising a video decoder for decoding the received images and a screen controller for controlling the display of decoded images on the screen. The video decoder comprises motion detection means for detecting variations between successive images and for deriving motion information. The screen controller comprises a control means for selectively refreshing display zones of the screen with refreshing frequencies determined as a function of the motion information provided by the decoder.

In accordance with an important characteristic feature of the invention, the video decoder comprises means for identifying video objects in the received video images, and the motion detection means are provided for detecting variations in the identified objects, the motion information being associated with an identified object so as to describe motion of this object between successive images.

The invention also relates to a method of refreshing successive video images displayed on a video screen, the method comprising a preliminary step of decoding video images for computing motion parameters describing variations between successive images, and a step of selectively refreshing display zones on the screen with different refreshing frequencies as a function of the previously computed motion parameters.

These and other aspects of the invention are apparent from and will be elucidated, by way of non-limitative example, with reference to the embodiment(s) described hereinafter.

In the drawings:

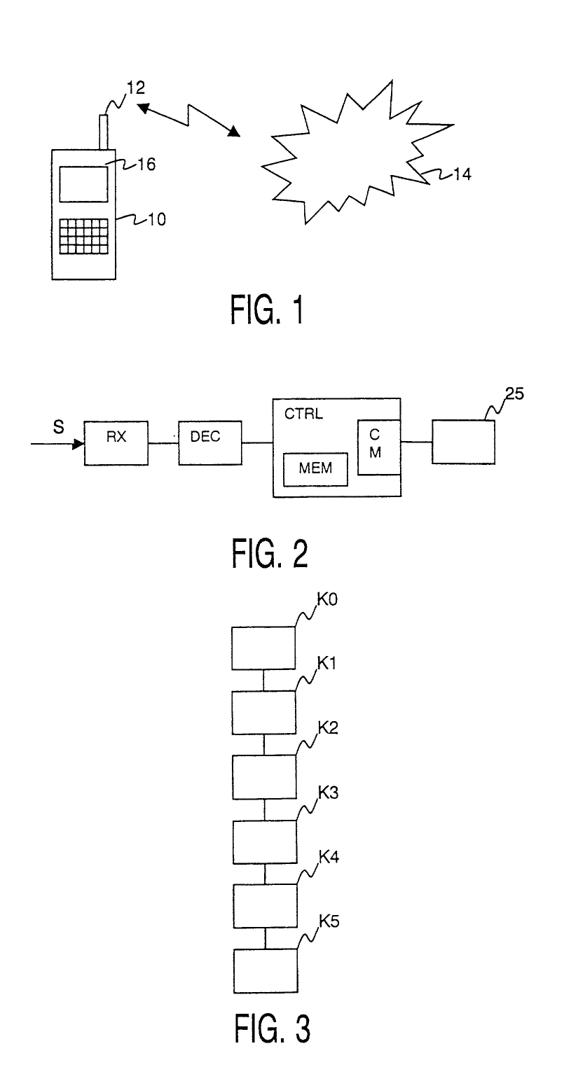

FIG. 1 is a diagram showing a receiver having a screen according to the invention.

FIG. 2 is a diagram for illustrating the operation of the receiver according to the invention.

FIG. 3 is a flow chart for illustrating a method of refreshing the screen according to the invention.

The embodiment of the receiver shown in FIG. 1 is a telephone radio receiver 10 in conformity with a standard of the UMTS type (Universal Mobile Telecommunication System). However, the invention may also be advantageously used in other telecommunication systems with which video images can be transmitted and received.

The receiver comprises a transmission/reception antenna 12 for transmitting and receiving video images transmitted by radio via a transmission system 14, and a video display screen 16 for displaying the received video images.

FIG. 2 is a block diagram of a receiver for carrying out the invention. The functions of each block may be, for example, effected by components situated within the telephone 10. Reception means RX allow reception of a video signal S representing encoded digital video images. A digital decoder DEC decodes these images so as to transmit them to a screen controller CTRL provided with storage means MEM for storing the images before displaying them on a video screen 25. The screen controller comprises a control means CM for triggering the refreshing of the screen.

According to the invention, the video decoder DEC comprises motion detection means for detecting variations between the received successive images and for deriving motion information. Such a decoder is, for example, based on the MPEG2 or 4 standard. The standard recommends the use of such motion information for only transmitting the motion vectors associated with the video objects constituting the image instead of transmitting the complete image to the receiver. While transmitting only displacement parameters describing the displacement of objects between two successive images, the total number of transmitted data is thus reduced considerably.

The invention uses this motion information provided by the decoder DEC, for example, in the form of displacement vectors or parameters, for selectively refreshing display zones of the screen as a function of the relative mobility of objects present in this zone. This information may be used, for example, for refreshing only the zones of the screen comprising mobile objects, rather than refreshing the other zones comprising objects which are stationary from one image to the other. As a variant, priorities may be defined. The zones to be refreshed first, as well as the optimal refreshing rate for each zone may be determined as a function of the motion information provided by the video decoder.

For example, in the case of a receiver of the MPEG4 standard, the decoder is provided with means for identifying video objects constituting the received image. A motion vector describing the displacement of the object between two video images is associated with each video object. In accordance with an embodiment of the invention, threshold values associated with predetermined refreshing rates are defined, which threshold values represent predetermined displacement amplitudes from which the screen zone concerned must be refreshed at the associated refreshing rate. If the screen has a certain persistence, it is even envisaged not to refresh the full screen or solely the zones not comprising movable objects until after the expiration of the delay provided by the constructor. At the end of this delay, the luminance of the screen becomes weaker and it is necessary to refresh it. However, apart from this aspect associated with the persistence of the screen, the refreshing of all the zones of the screen comprising objects identified by the decoder DEC may be effected in a selective manner by selecting the optimal rate as a function of the displacement of the video objects constituting the successive images.

FIG. 3 illustrates an example of the method of refreshing a video screen in accordance with the invention. The method comprises the following steps, denoted by K0 to K5.

K0, reception of encoded video images,

K1, decoding of received video images,

K2, identification of video objects constituting the images,

K3, determination of the motion vectors associated with the identified objects,

K4, selection of the predetermined refreshing rates for selectively refreshing zones of the screen as a function of the amplitude of the motion vectors associated with the identified video objects,

K5, triggering a command for selectively refreshing different zones of the screen, in accordance with the selection effected in the preceding step.

1. A receiver having a video display screen for receiving successive encoded video images, the receiver comprising a video decoder for decoding the received images and a screen controller for controlling the display of decoded images on the screen, the video decoder comprising motion detection means for detecting variations between successive images and for deriving motion information, the screen controller comprising a control means for selectively refreshing display zones on the screen with refreshing frequencies determined as a function of the motion information provided by the decoder.

2. A receiver as claimed in claim 1, wherein the video decoder comprises means for identifying video objects in the received video images, the motion detection means being provided for detecting variations in the identified objects and the motion information being associated with an identified object so as to describe motion of said object between successive images.

3. A receiver as claimed in claim 1 or 2, wherein the motion information comprises a motion vector representing a displacement of the video object in a plane parallel to the image.

4. A receiver as claimed in any one of claims 1 to 3, wherein the display screen is persistent and wherein the zones to be refreshed as well as the refreshing rates are determined as a function of the amplitude of motion of the video objects present in said zones.

5. A receiver as claimed in any one of claims 1 to 4, wherein the video decoder is conform to a standard of the MPEG2 or 4 type.

6. A method of refreshing successive video images displayed on a video screen, the method comprising a preliminary step of decoding video images for computing motion parameters describing variations between successive images, and a step of selectively refreshing display zones on the screen with different refreshing frequencies as a function of the previously computed motion parameters.

7. A computer program product for a receiver as claimed in any one of claims 1 to 6, the product comprising software code portions which, once loaded into the receiver, enable said receiver to execute the steps of the method as claimed in claim 6.

8. Portable electronic equipment having a video display screen for displaying video images, the equipment comprising a receiver as claimed in any one of claims 1 to 5, for receiving said video images.
